(19) United States
(12) Patent Application Publication
(10) Pub. No.: US 2023/0128369 A1
(43) Pub. Date: Apr. 27, 2023

(54) DEVICE FOR INSPECTING SEMICONDUCTOR EQUIPMENT AIR VALVE FOR LEAKING

(71) Applicant: SPSGLOBAL Co., Ltd, Cheonan-si (KR)

(72) Inventor: Sang Hyub LEE, Cheonan-si (KR)

(21) Appl. No.: 17/524,109

(22) Filed: Nov. 11, 2021

(30) Foreign Application Priority Data
Oct. 26, 2021 (KR) 10-2021-0143339

(51) Int. Cl. G01M 3/28

(52) U.S. Cl. CPC G01M 3/2876

(57) ABSTRACT

A device for inspecting a semiconductor equipment air valve for leaking is provided. The device includes: an air valve configured to generate a high vacuum state; an inspection device body installed on a first side of the air valve; a sensor part installed on a first side of the inspection device body to sense audio data, pressure data, video data, displacement data, infrared data, and ultrasound data of the air valve; an MCU installed inside the inspection device body; a screen output part installed outside the inspection device body to output image data; and a voice output part installed on the first side of the inspection device body to output voice data.

### CROSS REFERENCE TO RELATED APPLICATION

The present application claims priority to Korean Application No. 10-2021-0143339 filed on Oct. 26, 2021, which is incorporated herein by reference in its entirety.

### BACKGROUND

### 1. Technical Field

The present disclosure relates to a device for inspecting a semiconductor equipment air valve for leaking and, more particularly, to a device for inspecting a semiconductor equipment air valve for leaking configured to sense air valve data including audio data, pressure data, video data, displacement data, infrared data, and ultrasound data, perform deep learning on each piece of the sensed audio data, pressure data, video data, displacement data, infrared data, and ultrasound data by using machine learning software that utilizes a neural network compiler running on a microcontroller unit (MCU), and determine the air valve leak by generating a deep learning solution for the air valve leak, thereby outputting image data and voice data.

### 2. Description of the Related Art

A conventional device for inspecting a semiconductor equipment air valve for leaking injects helium directly into a section where the air leak occurs, and determines the air leak according to whether helium is detected. Such a conventional device for inspecting the air valve leak has a problem that helium has to be consumed, and precise leak inspection is difficult because the air leak is determined by using one type of sensor.

In addition, since a conventional self-learning device consumes a lot of power, and uses a System on Chip (SoC) with a large memory capacity, there is a problem that the conventional self-learning device is difficult to use in a terminal device.

### DOCUMENTS OF RELATED ART

(Patent Document 1) KR 10-2010-0021193 A
(Patent Document 2) KR 10-1893854 B1

### SUMMARY

The present disclosure has been devised to solve the above problems, and an objective of the present disclosure is to provide a device for inspecting a semiconductor equipment air valve for leaking configured to sense air valve data including audio data, pressure data, video data, displacement data, infrared data, and ultrasound data, perform deep learning on each piece of the sensed audio data, pressure data, video data, displacement data, infrared data, and ultrasound data by using machine learning software that utilizes a neural network compiler running on an MCU, and determine the air valve leak by generating a deep learning solution for the air valve leak, thereby outputting image data and voice data.

In order to solve the above technical problems, according to the present disclosure, a device for inspecting a semiconductor equipment air valve for leaking includes: the air valve configured to generate a high vacuum state; an inspection device body installed on a first side of the air valve; a sensor part installed on a first side of the inspection device body to sense audio data, pressure data, video data, displacement data, infrared data, and ultrasound data of the air valve; an MCU installed inside the inspection device body; a screen output part installed outside the inspection device body to output image data; and a voice output part installed on the first side of the inspection device body to output voice data.

In addition, preferably, the sensor part may include: an audio sensor installed the inside of the inspection device body to sense the audio data of the air valve; a pressure sensor installed on the first side of the inspection device body to sense the pressure data of the air valve; a video sensor installed the outside of the inspection device body to sense the video data of the air valve; a displacement sensor installed the outside of the inspection device body to sense position data of an axis of the air valve; an infrared sensor installed the outside of the inspection device body to sense the infrared data of the air valve; and an ultrasound sensor installed the outside of the inspection device body to sense the ultrasound data of the air valve.

In addition, preferably, the MCU may include: a data collection part configured to collect the audio data, the pressure data, the video data, the displacement data, the infrared data, and the ultrasound data, which are sensed by the sensor part; a data analysis part configured to pre-process the data collected by the data collection part, and divide and analyze the pre-processed data; a data storage part configured to store the data analyzed by the data analysis part; a self-learning part configured to use the data stored in the data storage part, use machine learning software using a neural network compiler operated in the MCU, perform deep learning on each piece of the audio data, the pressure data, the video data, the displacement data, the infrared data, and the ultrasound data, and generate a deep learning solution for the leak of the air valve; a deep learning solution storage part configured to store the deep learning solution generated by the self-learning part; and a leak determination part configured to use the deep learning solution stored in the deep learning solution storage part, determine a leak of the air valve on the basis of each piece of data including the audio data, the pressure data, the video data, the displacement data, the infrared data, and the ultrasound data of the air valve, by using the deep learning solution, assign a weight to whether the leak occurs or not, which is determined by each piece of the data, and determine whether the leak of the air valve occurs or not according to a total sum of each weight, thereby generating a leak signal.

In addition, preferably, the leak determination part may be configured to assign a weight of two when the leak is determined through the audio data, assign a weight of six when the leak is determined through the pressure data, assign a weight of one when the leak is determined through the video data, assign a weight of four when the leak is determined through the displacement data, assign the weight of six when the leak is determined through the infrared data, and assign the weight of one when the leak is determined through the ultrasound data, thereby generating the leak signal when the total sum of each weight is 10 or more.

In addition, preferably, the self-learning part may be configured to use machine learning software using a neural network compiler operated in the MCU, and perform the deep learning on each piece of the audio data, the pressure data, the video data, the displacement data, the infrared data, and the ultrasound data, thereby generating the deep learning solution for the leak of the air valve.

In addition, preferably, the screen output part may be configured to output, as the image data, data analyzed by a data analysis part and a leak signal generated by a leak determination part, and the voice output part may be configured to output, as the voice data, the leak signal generated by the leak determination part.

In addition, preferably, a method performed by the device for inspecting the semiconductor equipment air valve for leaking may include: a first step S100 of sensing each piece of the audio data, the pressure data, the video data, the displacement data, the infrared data, and the ultrasound data of the air valve, and transmitting the data to a data collection part of the MCU; a second step S200 of preprocessing, by a data analysis part, each piece of the audio data, the pressure data, the video data, the displacement data, the infrared data, and the ultrasound data, which are sensed in the first step S100; a third step S300 of dividing, by the data analysis part, each piece of the audio data, the pressure data, the video data, the displacement data, the infrared data, and the ultrasound data, which are pre-processed in the second step S200; a fourth step S400 of analyzing, by the data analysis part, each piece of the audio data, the pressure data, the video data, the displacement data, the infrared data, and the ultrasound data, which are divided in the third step S300; a fifth step S500 of storing, by a data storage part, the audio data, the pressure data, the video data, the displacement data, the infrared data, and the ultrasound data, which are analyzed in the fourth step S400; a sixth step S600 of generating a deep learning solution, by a self-learning part of the MCU, for the audio data, the pressure data, the video data, the displacement data, the infrared data, and the ultrasound data, which are stored in the fifth step S500; a seventh step S700 of storing the deep learning solution generated in the sixth step S600; an eighth step S800 of determining a leak of the air valve on the basis of each piece of the audio data, the pressure data, the video data, the displacement data, the infrared data, and the ultrasound data, which are analyzed in the fourth step S400, by using the deep learning solution stored in the seventh step S700, assigning a weight of two when the leak is determined through the audio data, assigning a weight of six when the leak is determined through the pressure data, assigning a weight of one when the leak is determined through the video data, assigning a weight of four when the leak is determined through the displacement data, assigning the weight of six when the leak is determined through the infrared data, and assigning the weight of one when the leak is determined through the ultrasound data, thereby generating a leak signal when a total sum of each weight is 10 or more; and a ninth step S900 of outputting the leak signal generated in the eighth step S800 and the data analyzed in the fourth step S400, as an image from the screen output part and as a voice from the voice output part.

According to the device for inspecting the semiconductor equipment air valve for leaking of the present disclosure implemented as described above, the following effects may be obtained.

According to an exemplary embodiment of the present disclosure, the device for inspecting the semiconductor equipment air valve for leaking may be configured to sense air valve data including audio data, pressure data, video data, displacement data, infrared data, and ultrasound data, perform deep learning on each piece of the sensed audio data, pressure data, video data, displacement data, infrared data, and ultrasound data by using machine learning software that utilizes a neural network compiler running on an MCU, and determine the air valve leak by generating a deep learning solution for the air valve leak, thereby outputting image data and audio data.

The present disclosure has been described with reference to the exemplary embodiment shown in the drawings, but these are only exemplary, and those skilled in the art will appreciate that various modifications and other equivalent embodiments are possible. Therefore, the true technical protection scope of the present disclosure will be defined by the technical spirit of the appended patent claims.

### BRIEF DESCRIPTION OF THE DRAWINGS

FIG. 1 is a perspective view illustrating an air valve of a device for inspecting a semiconductor equipment air valve for leaking according to a preferred exemplary embodiment of the present disclosure.

FIG. 2 is a block diagram illustrating the device for inspecting the semiconductor equipment air valve for leaking according to the preferred exemplary embodiment of the present disclosure.

FIG. 3 is a detailed configuration diagram illustrating an MCU of the device for inspecting the semiconductor equipment air valve for leaking according to the preferred exemplary embodiment of the present disclosure.

FIG. 4 is a flowchart illustrating an operation method of the device for inspecting the semiconductor equipment air valve for leaking according to the preferred exemplary embodiment of the present disclosure.

### DETAILED DESCRIPTION

Hereinafter, an exemplary embodiment of the present disclosure will be described with reference to the accompanying drawings in order to describe in detail enough that those skilled in the art may easily implement the technical idea of the present disclosure.

However, the following exemplary embodiment is merely an example to help the understanding of the present disclosure, whereby the scope of the present disclosure may not be reduced or limited. In addition, the present disclosure is not limited to the exemplary embodiment described herein and may be implemented in many different forms.

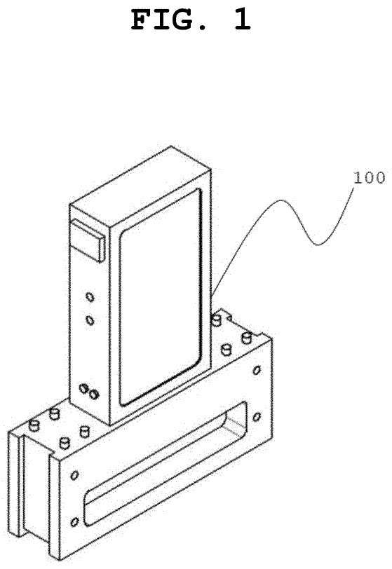

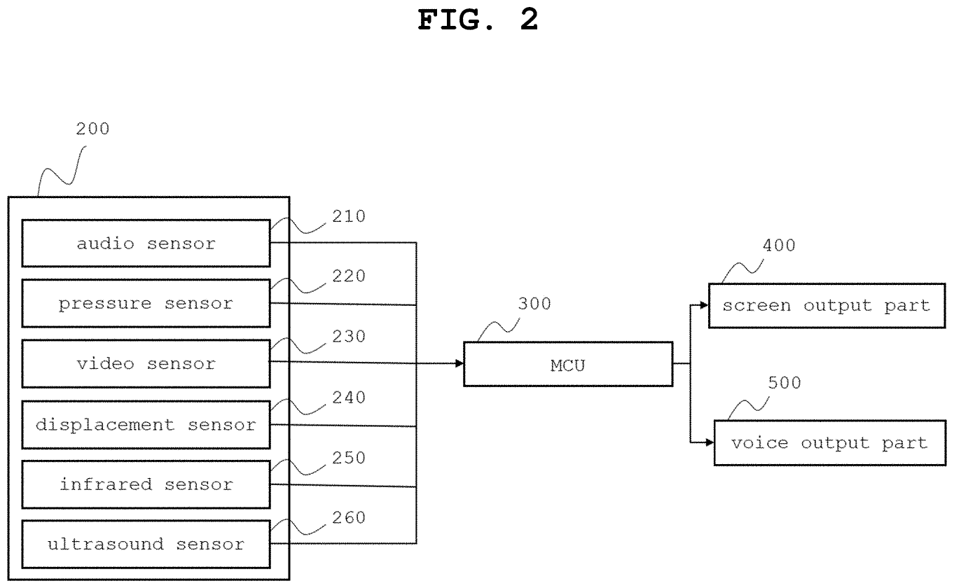

FIG. 1 is a perspective view illustrating an air valve air of a device for inspecting a semiconductor equipment air valve for leaking according to a preferred exemplary embodiment of the present disclosure, and FIG. 2 is a block diagram illustrating the device for inspecting the semiconductor equipment air valve for leaking according to the preferred exemplary embodiment of the present disclosure.

Referring to FIGS. 1 and 2, the device for inspecting the semiconductor equipment air valve for leaking according to the exemplary embodiment of the present disclosure includes an air valve 100, an inspection device body (not shown), a sensor part 200, an MCU 300, a screen output part 400, and a voice output part 500.

In this case, the air valve 100 is a valve that opens and closes a gap between an external space and a process space in a semiconductor manufacturing process.

In addition, the inspection device body (not shown) is installed on one side of the air valve 100.

The sensor part 200 may be installed inside the inspection device body (not shown) and be configured to include an audio sensor 210, a pressure sensor 220, a video sensor 230, a displacement sensor 240, an infrared sensor 250, and an ultrasound sensor 260.

The screen output part 400 may output, as image data, data analyzed by a data analysis part 320 and a leak signal generated by a leak determination part 360, and the voice output part 500 may output, as voice data, the leak signal generated by the leak determination part 360.

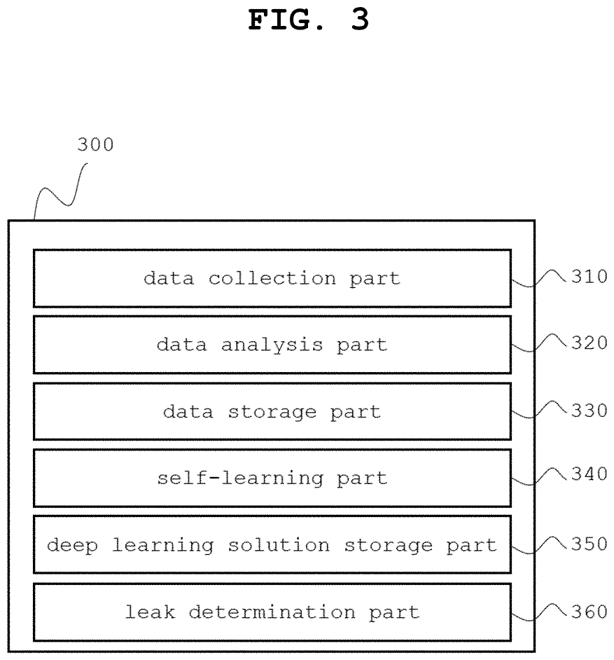

FIG. 3 is a detailed configuration diagram illustrating an MCU 300 of the device for inspecting the semiconductor equipment air valve for leaking according to the preferred exemplary embodiment of the present disclosure.

Referring to FIG. 3, the MCU 300 may include: a data collection part 310 configured to collect data sensed by the sensor part 200; a data analysis part 320 configured to analyze the data collected by the data collection part 310; a data storage part 330 configured to store the data analyzed by the data analysis part 340; a self-learning part 340 configured to use the data stored in the data storage part 330, use machine learning software using a neural network compiler operated in the MCU 300, perform deep learning on each piece of audio data, pressure data, video data, displacement data, infrared data, and ultrasound data, and generate a deep learning solution for the leak of the air valve 100; a deep learning solution storage part 350 configured to store the deep learning solution generated by the self-learning part 340; and a leak determination part 360 configured to determine the leak of the air valve 100 on the basis of each piece of the audio data, the pressure data, the video data, the displacement data, the infrared data, and the ultrasound data of the air valve 100 by using the deep learning solution stored in the deep learning solution storage part 350, assign a weight to whether the leak occurs determined by each piece of the data, and determine whether the air valve 100 leaks according to a total sum of each weight, thereby generating a leak signal.

The leak signal generated by the total sum of each weight in the leak determination part 360 should have high accuracy.

### Experimental Example 1: Accuracy of Leak Signal According to Weight Setting

The sensors including the audio sensor 210, the pressure sensor 220, the video sensor 230, the displacement sensor 240, the infrared sensor 250, and the ultrasound sensor 260, which are generally used in a semiconductor process, are used to assign a weight to each of the sensors, so that whether the air valve 100 leaks or not is determined, whereby the accuracy is measured 200 times, and the leak signal is generated according to the determination of whether the leak occurs.

TABLE 1
Accuracy of leak signal that occurs when total sum
of each weight according to weight setting is 10

| | Embodi- | Embodi- | Embodi- | Embodi- | Embodi- |
|---|---|---|---|---|---|
| | ment 1 | ment 2 | ment 3 | ment 4 | ment 5 |
| Voice sensor | 2 | 5 | 2 | 6 | 3 |
| Pressure | 2 | 5 | 6 | 2 | 3 |
| sensor | | | | | |
| Image sensor | 2 | 5 | 1 | 6 | 3 |
| Dis- | 2 | 5 | 4 | 2 | 3 |
| placement | | | | | |
| sensor | | | | | |
| Infrared | 2 | 5 | 6 | 2 | 6 |
| sensor | | | | | |
| Ultrasonic | 2 | 5 | 1 | 6 | 6 |
| sensor | | | | | |
| Accuracy % | 76 | 87 | 98 | 77 | 82 |

Therefore, for the leak determination part 360 of the device for inspecting the semiconductor equipment air valve for leaking according to the present disclosure, as shown in Embodiment 3, it is preferable to assign a weight of two when a leak is determined through the audio data, assign a weight of six when a leak is determined through the pressure data, assign a weight of one when a leak is determined through the video data, assign a weight of four when a leak is determined through the displacement data, assign a weight of six when a leak is determined through the infrared data, and assign a weight of one when a leak is determined through the ultrasound data, so as to generate the leak signal when the total sum of each weight is 10 or more.

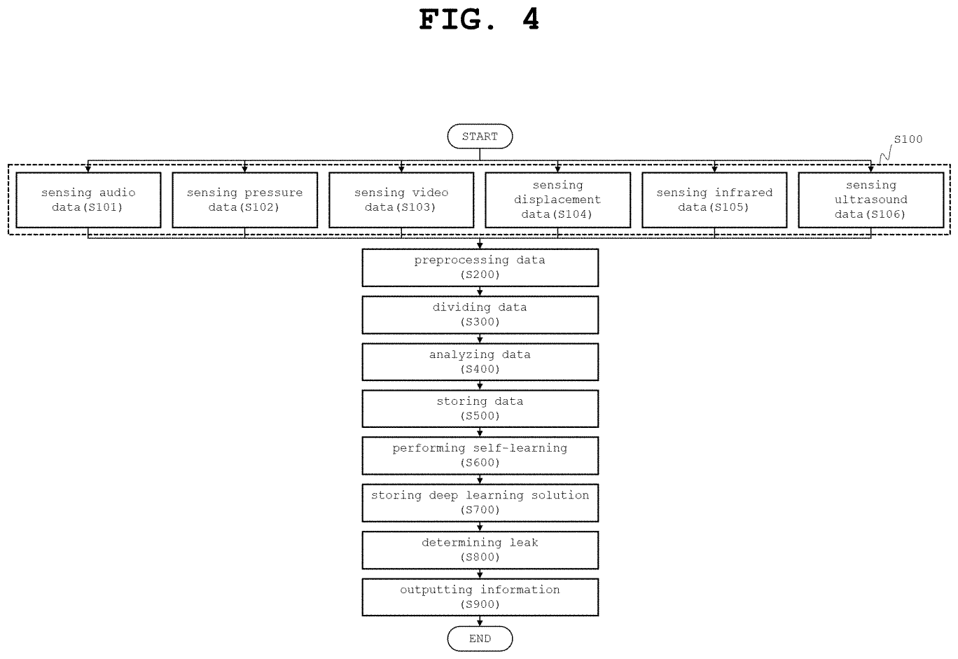

FIG. 4 is a flowchart illustrating an operation method of the device for inspecting the semiconductor equipment air valve for leaking according to the preferred exemplary embodiment of the present disclosure.

Referring to FIG. 4, an inspection method of the device for inspecting the semiconductor equipment air valve for leaking may include: a first step S100 of sensing each piece of audio data, pressure data, video data, displacement data, infrared data, and ultrasound data of the air valve 100, and transmitting the data to the data collection part 310 of the MCU 300; a second step S200 of preprocessing, by the data analysis part 320, each piece of the audio data, the pressure data, the video data, the displacement data, the infrared data, and the ultrasound data, which are sensed in the first step S100; a third step S300 of dividing, by the data analysis part 320, each piece of the audio data, the pressure data, the video data, the displacement data, the infrared data, and the ultrasound data, which are pre-processed in the second step S200; a fourth step S400 of analyzing, by the data analysis part 320, each piece of the audio data, the pressure data, the video data, the displacement data, the infrared data, and the ultrasound data, which are divided in the third step S300; a fifth step S500 of storing, by the data storage part, the audio data, the pressure data, the video data, the displacement data, the infrared data, and the ultrasound data, which are analyzed in the fourth step S400; a sixth step S600 of generating a deep learning solution, by the self-learning part 340 of the MCU 300, for the audio data, the pressure data, the video data, the displacement data, the infrared data, and the ultrasound data, which are stored in the fifth step S500; a seventh step S700 of storing the deep learning solution generated in the sixth step S600; an eighth step S800 of determining a leak of the air valve 100 on the basis of each piece of the audio data, the pressure data, the video data, the displacement data, the infrared data, and the ultrasound data, which are analyzed in the fourth step S400, by using the deep learning solution stored in the seventh step S700, assigning a weight of two when a leak is determined through the audio data, assigning a weight of six when a leak is determined through the pressure data, assigning a weight of one when a leak is determined through the video data, assigning a weight of four when a leak is determined through the displacement data, assigning a weight of six when a leak is determined through the infrared data, and assigning a weight of one when a leak is determined through the ultrasound data, thereby generating a leak signal when a total sum of each weight is 10 or more; and a ninth step S900 of outputting the leak signal generated in the eighth step S800 and the data analyzed in the fourth step S400, as an image from the screen output part 400 and as a voice from the voice output part 500.

As described above, the present disclosure has the device for inspecting the semiconductor equipment air valve for leaking as a major technical idea. The exemplary embodiment described above with reference to the drawings is merely one of exemplary embodiments, and the true scope of the present disclosure is based on the claims, but the scope will also extend to equivalent exemplary embodiments that may exist in various ways.

What is claimed is:

1. A device for inspecting a semiconductor equipment air valve for leaking, the device comprising:
an air valve configured to generate a high vacuum state;
an inspection device body installed on a first side of the air valve;
a sensor part installed on a first side of the inspection device body to sense audio data, pressure data, video data, displacement data, infrared data, and ultrasound data of the air valve;
an MCU installed inside the inspection device body;
a screen output part installed outside the inspection device body to output image data; and
a voice output part installed on the first side of the inspection device body to output voice data.

2. The device of claim 1, wherein the sensor part comprises:
an audio sensor installed the inside of the inspection device body to sense the audio data of the air valve;
a pressure sensor installed on the first side of the inspection device body to sense the pressure data of the air valve;
a video sensor installed the outside of the inspection device body to sense the video data of the air valve;
a displacement sensor installed the outside of the inspection device body to sense position data of an axis of the air valve;
an infrared sensor installed the outside of the inspection device body to sense the infrared data of the air valve; and
an ultrasound sensor installed the outside of the inspection device body to sense the ultrasound data of the air valve.

3. The device of claim 1, wherein the MCU comprises:
a data collection part configured to collect the audio data, the pressure data, the video data, the displacement data, the infrared data, and the ultrasound data, which are sensed by the sensor part;
a data analysis part configured to pre-process the data collected by the data collection part, and divide and analyze the pre-processed data;
a data storage part configured to store the data analyzed by the data analysis part;
a self-learning part configured to perform deep learning by using the data stored in the data storage part, so as to generate a deep learning solution;
a deep learning solution storage part configured to store the deep learning solution generated by the self-learning part; and
a leak determination part configured to use the deep learning solution stored in the deep learning solution storage part, determine a leak of the air valve on the basis of each piece of data including the audio data, the pressure data, the video data, the displacement data, the infrared data, and the ultrasound data of the air valve, by using the deep learning solution, assign a weight to whether the leak occurs or not, which is determined by each piece of the data, and determine whether the leak of the air valve occurs or not according to a total sum of each weight, thereby generating a leak signal.

4. The device of claim 3, wherein the leak determination part is configured to assign a weight of two when the leak is determined through the audio data, assign a weight of six when the leak is determined through the pressure data, assign a weight of one when the leak is determined through the video data, assign a weight of four when the leak is determined through the displacement data, assign the weight of six when the leak is determined through the infrared data, and assign the weight of one when the leak is determined through the ultrasound data, thereby generating the leak signal when the total sum of each weight is 10 or more.

5. The device of claim 3, wherein the self-learning part is configured to use machine learning software using a neural network compiler operated in the MCU, and perform the deep learning on each piece of the audio data, the pressure data, the video data, the displacement data, the infrared data, and the ultrasound data, thereby generating the deep learning solution for the leak of the air valve.

6. The device of claim 1, wherein the screen output part is configured to output, as the image data, data analyzed by a data analysis part and a leak signal generated by a leak determination part, and
wherein the voice output part is configured to output, as the voice data, the leak signal generated by the leak determination part.

7. The device of claim 1, wherein a method performed by the device for inspecting the semiconductor equipment air valve for leaking comprises:
a first step (S100) of sensing each piece of the audio data, the pressure data, the video data, the displacement data, the infrared data, and the ultrasound data of the air valve, and transmitting the data to a data collection part of the MCU;
a second step (S200) of preprocessing, by a data analysis part, each piece of the audio data, the pressure data, the video data, the displacement data, the infrared data, and the ultrasound data, which are sensed in the first step (S100);
a third step (S300) of dividing, by the data analysis part, each piece of the audio data, the pressure data, the video data, the displacement data, the infrared data, and the ultrasound data, which are pre-processed in the second step (S200);
a fourth step (S400) of analyzing, by the data analysis part, each piece of the audio data, the pressure data, the video data, the displacement data, the infrared data, and the ultrasound data, which are divided in the third step (S300);
a fifth step (S500) of storing, by a data storage part, the audio data, the pressure data, the video data, the displacement data, the infrared data, and the ultrasound data, which are analyzed in the fourth step (S400);
a sixth step (S600) of generating a deep learning solution, by a self-learning part of the MCU, for the audio data, the pressure data, the video data, the displacement data, the infrared data, and the ultrasound data, which are stored in the fifth step (S500);
a seventh step (S700) of storing the deep learning solution generated in the sixth step (S600);
an eighth step (S800) of determining a leak of the air valve on the basis of each piece of the audio data, the pressure data, the video data, the displacement data, the infrared data, and the ultrasound data, which are analyzed in the fourth step (S400), by using the deep learning solution stored in the seventh step (S700), assigning a weight of two when the leak is determined through the audio data, assigning a weight of six when the leak is determined through the pressure data, assigning a weight of one when the leak is determined through the video data, assigning a weight of four when the leak is determined through the displacement data, assigning the weight of six when the leak is determined through the infrared data, and assigning the weight of one when the leak is determined through the ultrasound data, thereby generating a leak signal when a total sum of each weight is 10 or more; and
a ninth step (S900) of outputting the leak signal generated in the eighth step (S800) and the data analyzed in the fourth step (S400), as an image from the screen output part and as a voice from the voice output part.
